(19) United States
(12) Patent Application Publication
(10) Pub. No.: US 2003/0193933 A1
(43) Pub. Date: Oct. 16, 2003

(54) Method and apparatus for transmitting and routing voice telephone calls over a packet switched computer network

(75) Inventors: Howard Jonas, Bronx, NY (US); Eric Raab, East Brunswick, NJ (US); Harold Jeffrey Goldberg, Lakewood, NJ (US)

Correspondence Address: OBLON, SPIVAK, MCCLELLAND, MAIER & NEUSTADT, P.C., 1940 DUKE STREET, ALEXANDRIA, VA, 22314, US

(73) Assignee: Net2Phone, Inc., Newark, NJ (US)

(21) Appl. No.: 10/454,533

(22) Filed: Jun. 5, 2003

Related U.S. Application Data
(63) Continuation of application No. 09/683,760, filed on Feb. 11, 2002, now abandoned.
Application No. 09/683,760 is a continuation of application No. 08/542,641, filed on Oct. 13, 1995, now abandoned.

(51) Int. Cl. H04L 12/66

(52) U.S. Cl. 370/352

(57) ABSTRACT

A method and system for routing and transmitting voice conversations across a packet switched computer network and a circuit switched public telephone network is provided. Conversion between packet switched computer network protocols and circuit switched telephone network protocols is performed by one or more phone switches which are coupled to the packet switched computer network and the circuit switched telephone network. Routing voice conversations among multiple phone switches coupled to the packet switched computer network is performed by one or more routing servers coupled to the packet switched computer network, or a user's local computer.

### CROSS-REFERENCE TO RELATED APPLICATIONS

This application is a continuation of application Ser. No. 09/683,760, filed Feb. 11, 2002, which is a continuation of application Ser. No. 08/542,641, filed Oct. 13, 1995. The entire contents of both of those applications are herein incorporated by reference.

### BACKGROUND OF THE INVENTION

1. Field of the Invention

This invention relates to a method and architecture for the transmission and routing of voice signals over a packet switched network and more particularly to a method and system for routing and converting voice signals between a circuit switched public telephone network (“circuit switched telephone network”) and a packet switched computer network.

2. Background of the Invention

The advantages of transmitting voice information in packet form has long been recognized. Packet switching provides a ready solution to problems where the voice information to be transmitted occurs in bursts, with significant pauses between bursts. The application of compression techniques to digitized voice transmissions often results in such characteristic transmissions.

Traditional telephone service, the so-called Plain old Telephone Service (“POTS”), is provided over a circuit switched telephone network which dedicates a sequence of physical links through nodes of the circuit switched telephone network between POTS stations. At each node, incoming voice signals are routed to the appropriate outgoing channel without delay. Circuit switched networks typically dedicate a multiplexed communication path, in space and/or time division multiplexing, between the caller and called party which lasts throughout the duration of the call.

In contrast, in packet switched networks, which are typically associated with the transmission of “data” rather than voice conversations, it is not necessary to dedicate transmission capacity along a sequence of physical links through the network. Instead, data is sent in packets which are passed from node to node through the network. Each data packet typically consists of several items including the address of the data source, the address of the data destination, error checking information, as well as the actual data sent. Each node briefly stores and analyzes the packet and then transmits it to the next node.

Current technologies allow a voice signal to be digitized and compressed. When a number of compressed digitized voice conversations are transmitted over a network, significant savings in bandwidth can be realized through packet switched transmission of the voice conversations. As noted above, traditional circuit switched networks require a constant allocation of bandwidth for each voice channel on the network. Statistically, this results in inefficient use of bandwidth due to the large amount of time in which relatively little voice information is being transmitted. For example, for many voice conversations a single voice channel at a time is sufficient during a large portion of the conversation. Compression techniques are available which reduce the total voice data being transmitted, however, these techniques often result in bursts of data over limited durations. To accommodate these potential bursts of data transmissions, circuit switched networks must allocate a constant bandwidth for each voice channel which is sufficiently large to transmit the “widest” burst of data possible. Thus, while compression techniques can realize tremendous savings in terms of total data transmitted, they nevertheless require a relatively inefficient allocation of bandwidth in a circuit switched network. Packet switched transmission of voice information, in contrast, may reduce total system bandwidth, and result in a lower cost system, by multiplexing a number of simultaneous voice conversations in such a manner as to take advantage of the statistical characteristics of the compressed digital voice data.

Personal computers equipped with available signal processing audio boards allow a user's voice to be digitized and transmitted to a second personal computer. This second personal computer will then convert the digitized transmission back to an analog audio signal and amplify the signal for an audio output, reproducing the first user's voice. A pair of modems are typically used to transmit the digitized information.

In one mode of operation, the digitized voice information is transmitted directly over a circuit switched telephone network to the second personal computer. In a second mode of operation, the digitized voice information is transmitted via a packet switched network to a second computer which is also connected to the packet switched network. Typically, the packet switched network will be the World-Wide Internet (“Internet”). The Internet Phone.™., available from VocalTech Inc., Northvale, N.J., and the Personal Internet Companion Kit.™. available from Camelot Corp., Dallas, Tex., make use of this second mode of operation for communicating between two audio ready computers coupled to the Internet.

Transmission of digitized voice conversations through this second mode of operation over long distances allows the user to save significant amounts of money. This reduced cost is partially a result of the efficiency of packet switched networks over circuit switched networks. Additionally, the user's savings is also a result of the fact that packet switched networks typically charge the user based on either the amount of information transmitted or the user's connect time, rather than as a function of the distance the voice conversation travels, as is typical in circuit switched telephone networks. While transmission of voice conversations through a packet switched network may result in some respects in a lower quality sound, due to the occasional delays introduced at the system nodes or loss of data, many users may accept such delays as a tradeoff in order to realize a significant cost savings.

The protocols and addressing mechanisms utilized on circuit switched telephone networks and the Internet, however, are not compatible, and therefore do not allow a user to easily establish a voice conversation across the Internet which either originates or terminates on a POTS station. There exists a need, therefore, for a method and system for establishing a voice conversation between a POTS station coupled to a circuit switched telephone network and an audio ready computer connected to a packet switched computer network, such a as the Internet. Moreover, because such system ideally utilizes a plurality of gateways, or access points, to gain access to the circuit switchboard telephone network in a plurality of geographic locations, there further exists a need for a method and system for utilizing a plurality of gateways to route voice calls between a circuit switched telephone network and a packet switched computer network. There further exists a need for the method and system of authorizing such calls.

POTS users also may wish to utilize the Internet, or a similar packet switched computer network, to save money on voice conversations between POTS stations. There further exists a need, therefore, for a method and system of transmitting a voice conversation between two POTS stations where at least a portion of the voice conversation path between the two POTS stations is transmitted across a generally accessible, public packet switched computer network, such as the Internet.

### SUMMARY OF THE INVENTION

The object of the present invention is to provide a system for establishing a voice conversation from an audio ready computer connected to a packet switched computer network, such as the Internet, to a POTS station coupled to a circuit switched telephone network.

It is a further object of the present invention to provide a method and system of transmitting a voice conversation between two POTS stations wherein the voice conversation path between the two stations is routed through a public circuit switched telephone network and a public packet switched computer network, such as the Internet.

The present invention is directed to a method and system for routing and transmitting voice conversations between an audio ready computer and a POTS station through a packet switched computer network such as the Internet. The present invention further provides for a method and system for routing and transmitting a voice conversation between two POTS stations which is at least partially transmitted over a packet switched computer network. The POTS stations are coupled to the system through one or more circuit switched telephone networks. A routing server is provided for routing calls between multiple destinations on the packet switched computer network. A phone switch is also provided for converting protocols from a packet switched computer network to a circuit switched telephone network.

### BRIEF DESCRIPTION OF THE DRAWINGS

For a more complete understanding of the present invention, reference is made to the following Detailed Description taken in conjunction with the accompanying drawings in which:

FIG. 1 is a high level block diagram of a system architecture in accordance with the present invention;

FIG. 2A is a functional block diagram of a system architecture for supporting a voice conversation between an audio ready personal computer and a POTS station in accordance with the present invention;

FIG. 2B is a functional block diagram of a system architecture for supporting a voice conversation between two POTS stations across a packet switched computer network in accordance with the present invention;

FIG. 3 is a block diagram of a personal computer system in which client software of the present invention may be embodied;

FIG. 4A is a flowchart illustrating a method of implementing a phone switch for bridging voice conversations between the packet switched computer network and the circuit switched telephone network in accordance with the present invention;

FIG. 4B is a functional block diagram of a phone switch constructed in accordance with the present invention;

FIG. 5 is a flowchart illustrating a method for registering users with the system in accordance with the present invention;

FIG. 6 is a functional block diagram illustrating database models in accordance with the present invention; and

FIG. 7 is a schematic representation of a data packet for transmitting voice and/or control information in accordance with the present invention.

### DETAILED DESCRIPTION

Preferred embodiments of the present invention will now be described with continued reference to the drawings.

Overview

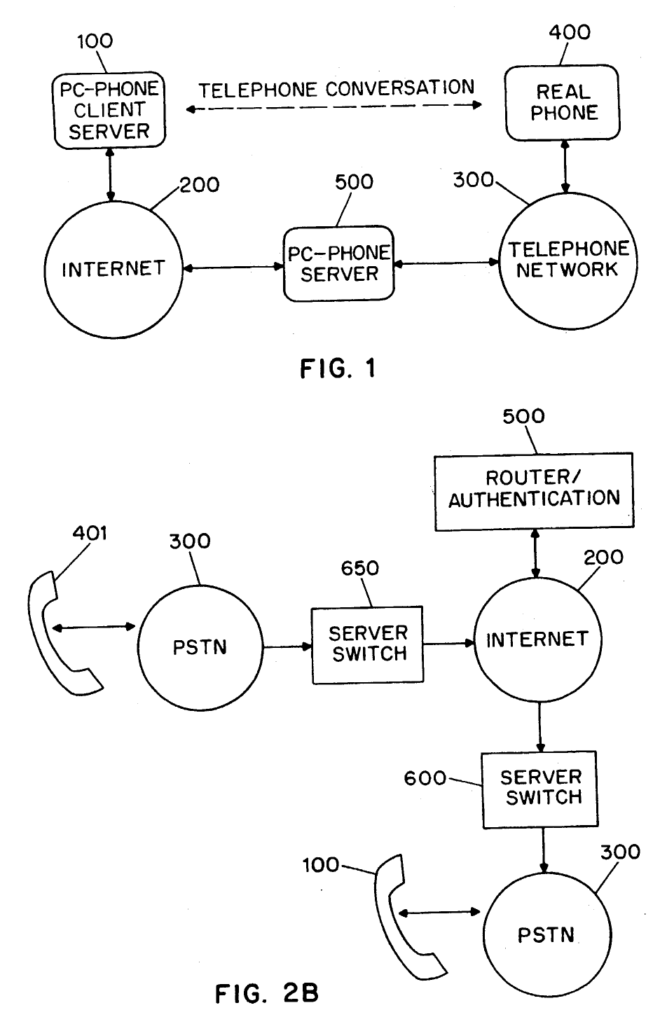

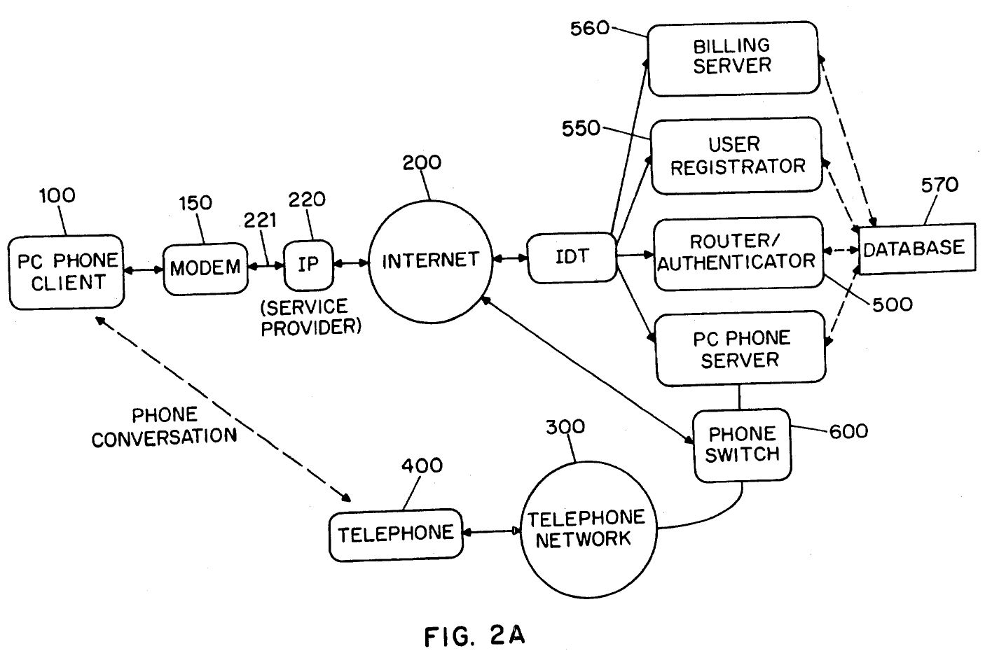

FIGS. 1 and 2A show an overall view of the system architecture. The system is composed of a personal computer 100 executing client application software 101 and a system server 500. To establish a voice conversation from the personal computer 100, the client application software 101 connects, over the computer network 200, to the router authentication server 500 and requests a voice connection to a specified phone number. The system server 500 uses a specialized phone switch 600 to dial the phone number via the circuit switched telephone network 300.

The preferred embodiment includes a plurality of phone switches 600 (FIG. 2A) in a number of locations. Each of the phone switches 600 are coupled to both the computer network 200 and the circuit switched telephone network 300. The router authentication server 500 determines the optimal phone switch 600 to route the call through based on the costs of connecting the called party to the phone switch over the circuit switched telephone network 300, as well as the traffic through the possible phone switches 600. In an alternative embodiment of the present invention, multiple router authentication servers 500 may be coupled to the packet switched computer network 200 at one or more geographical locations.

The personal computer 100 then sends the call request, including any authentication data provided by the router authentication server 500, to the phone switch 600. The phone switch 600 verifies the authentication data, either through communication with the router authentication server 500, or through other security means such as a digital signature generated by the router authentication server 500. The phone switch 600 sends a signal indicating off-hook to the circuit switched telephone network 300 and tones or pulses corresponding to the called party's phone number over the circuit switched telephone network 300. The phone switch 600 then waits for an answer signal from the circuit switched telephone network 300 indicating remote phone 400 has gone off-hook and answered the call. After the remote phone 400 answers and a call is established, the phone switch 600 then converts the voice data received from the circuit switched telephone network 300 into a format suitable for the packet switched computer network 200 and client application software 101 through any of a number of known conventional techniques for implementing such a gateway between two networks. Similarly, the phone switch 600 converts voice data received from the packet switched computer network 200 into a format suitable for the circuit switched telephone network 300 through conventional gateway techniques.

The personal computer 100 is physically connected to a network service provider 220 via a communications link 221 and modem 150 as is well known in the art. The communications link 221 may be a circuit switched telephone network, a dedicated connection, or any of a number of known means. The network service provider 220 provides the personal computer 100 access to the computer network 200. The computer network 200 is preferably the Internet.

Pc-Phone Client System

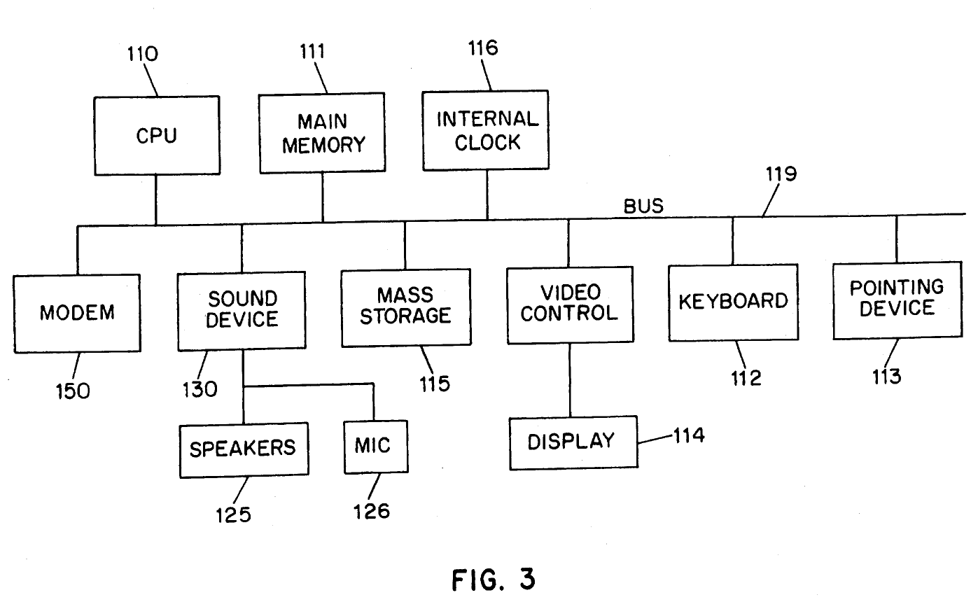

As shown in FIG. 3, one aspect of the present invention may be embodied on an audio ready personal computer 100, which comprises a central processor 110, a main memory 111, a keyboard 112, a pointing device 113, such as a mouse, glide-control or the like, a display device 114, a mass storage device 115, such as a hard disk, and an internal clock 116. The personal computer 100 also includes a sound device 130, including a signal processing unit 120. The system components of the personal computer 100 communicate through a system bus 119. In a preferred embodiment, the personal computer 100 is an IBM-compatible personal computer which is available from many vendors. The preferred central processor 110 will be compatible with an Intel 80486 operating at 33 MHz, or greater and most preferably an Intel Pentium.™. operating at 75 MHz or greater. Other computer systems, such as the Macintosh.™. available from Apple Computer, or the Sun SPARC.™. Station from Sun Microsystems.™., and other processors, such as the Motorola 680x0.™., the Sun Microsystems SPARC.™., and the PowerPC.™., jointly developed by Apple Computer, IBM and Motorola, are also suitable.

Additionally, the personal computer 100 is preferably connected to an internal or external modem 125 or like device for communication with the computer network 200. This modem is preferably capable of transmitting a minimum of 14.4 kbs, and most preferably transmits at 28.8 kbs or greater. Alternatively, the personal computer 100 may be connected via an ISDN adapter and an ISDN line for communications with the computer network 200 or via an Ethernet connection to a network connected to the Internet or any other type of network interface.

In the preferred embodiment, the sound device 130 may be any of a number of readily available sound cards, such as the SoundBlaster.™. card, available from Creative Labs, Inc. or the SoundChoice 32.™., available from Spectrum Signal Processing. The sound device 130 is connected one or more speakers 125 and a microphone 126. The sound device 130 may, optionally, include a standard RJ11 telephone jack for connection to a standard analog telephone.

The personal computer 100 is preferably under the control of a multi-tasking operating system including a TCP/IP interface, such as that available under Microsoft Windows.™., MacOS.™., UNIX.™., NextStep.™. or OS/2.™.

The personal computer may establish a connection to the packet switched computer network 200 via a network service provider 220 (FIG. 2A). Commercial network service providers include: IDT of Hackensack, N.J. and Performance Systems International. The network service provider preferably provides a Serial Line Internet Protocol (SLIP) or Point-to-Point Protocol (PPP) connection to the packet switched computer network 200.

The user initiates a call request by entering a standard telephone number through the client application software's 101 graphical user interface. Alternatively, the graphical user interface will allow the user to enter the called party's name or other information which the client application software 101 executing on personal computer 100 will translate to a standard telephone number based on the user's personalized database. The client application software 101 may further prompt the user for an access name and password, or credit card number, each time a call is established. Alternatively, the client application software 101 may store the user access name and password (or credit card) information when the user configures or first uses the software 101 and automatically forward the access name and password (or credit card) to the router authentication server 500.

The client application software 101 creates a call connection request packet containing the called party's phone number and the user's access information, such as credit card information or the user's access name and password. The called party's number may determined through an optional local or on-line directory. The call connection request packet is sent from the personal computer 100 to the router authentication server 500 (FIG. 2A). Upon receipt of the call connection request packet, the router authentication server 500 verifies the caller's access name and password and determines the appropriate phone switch 600 to route the call through based on a number of factors, including the traffic load on each of the phone switches 600, and the cost of transmitting the voice conversation from the potential phone switches 600 to the called party over the circuit switched telephone network 300.

An alternative embodiment of the present invention does not utilize a router authentication server. Instead, the client application software 101 itself selects a phone switch 600. The phone switch 600 will itself verify the caller's access name and password or credit card information. The client application software 101 may use any of a number of techniques for selecting the phone switch 600, including an internal database mapping destination area codes and central office exchanges to phone switches 600. This internal database may be periodically downloaded and updated through the packet switched computer network 200 as phone switches 600 are moved, added, deleted or temporarily made out of service.

The process for converting between an analog signal, such as the caller's voice input or audio output, and digitized packets suitable for transmission over the packet switched computer network 200 is well known on the art. A number of sound devices, such as the SoundBlaster.™. card, are available for converting between digital and analog audio signals. When converting from audio input to digitized packet data, the audio input is first sampled or digitized. This sampled data is then compressed utilizing any of a number of known speech compression algorithms such as GSM. In the preferred embodiment, the speech will be compressed to be transmitted at a rate of approximately 10 kilobytes/sec (kbs) in order to make use of a 14.4 kbs modem, leaving approximately 30% of the bandwidth available for control information. In the preferred embodiment, this algorithm will further be capable of achieving such compression on a personal computer utilizing an Intel 80486SX operating at 33 MHz at less than ½ full load.

The client application software 101 preferably is installed via a self-extracting file. The installation code determines whether the necessary hardware and software resources reside on the personal computer. This will include verifying the disk space and the presence of a sound device, and that the necessary drivers, such as sound drivers and the Windows socket interface (“winsock”), are installed. The installation process may also require the user to register with the user registration server 550 (FIG. 2A).

Computer Network

The computer network 700 is preferably the World-Wide Internet (“Internet”). The Internet is a world-wide network connecting thousands of computers (“hosts”) and computer networks. The Internet is organized as a multi-level hierarchy containing local networks connected to a number of regional, mid-level networks. Each of these regional networks is connected to a backbone network.

The dominant protocol used for transmitting information between computers on the Internet is the Transmission Control Protocol/Internet Protocol (TCP/IP) Network Protocol. Computers typically connect to the Internet through a local telephone network connecting the computer to an Internet service provider. Internet addresses are the addressing system used in TCP/IP communications to specify a particular network or computer on the network with which to communicate. Computers may either directly use the numeric internet address or, alternatively, a host name plus domain name. Host and domain names are then translated to Internet addresses by a resolver process.

User Registration Server and Biling Server

Referring now to FIG. 5, we describe the user registration server 550 and the billing server 560. The system preferably includes at least one user registration server 550 which stores user information, including access name, password, and billing information. The user may register either manually or through interaction with the client application software 101. The database is available to the other components of the system, such as the router authentication server 600 and the billing server 560.

The billing server 560 (FIG. 2A) maintains a database of call history for each call established through the system. The billing server 560 will bill the user, either immediately or on a monthly basis. The charge may be submitted directly to the user's credit card.

Phone Switch

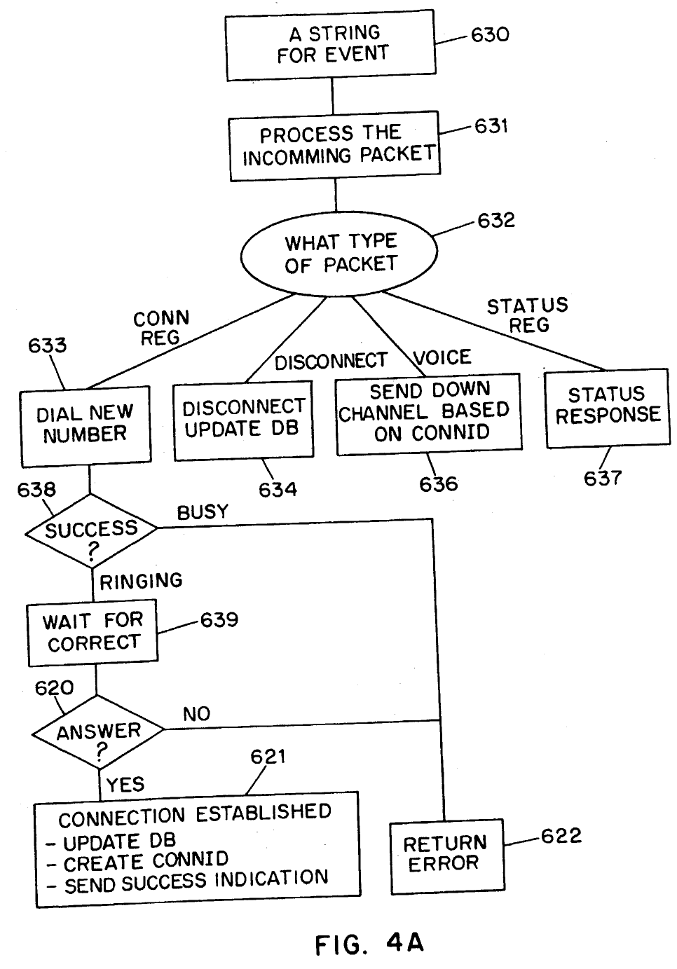

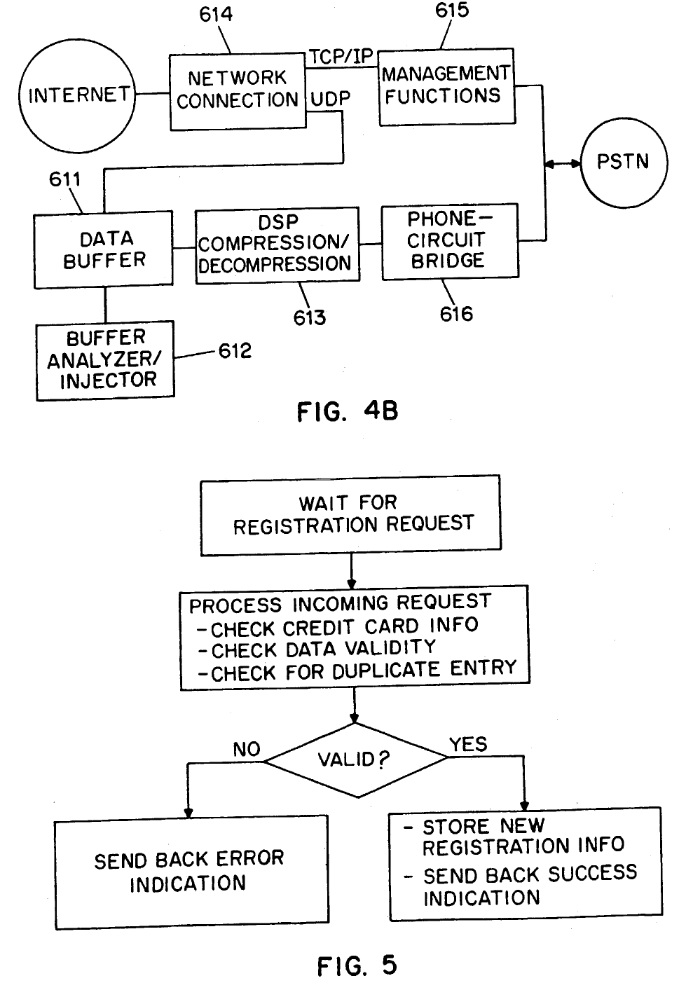

Referring now to FIG. 4B, the phone switch 600 acts as to convert between the packet data transmitted over the packet switched computer network 200 and the information transmitted over the circuit switched telephone network 300. The information transmitted over the circuit switched telephone network 300 may be in any of a variety of formats (also know as “protocols”), as described below, including analog or digital transmissions.

The phone switch 600 further performs the functions of data buffering 611, data injection 612 to smooth delays by using windows of several data buffers that initially contain data representing silence and overlaying time-stamped incoming packets. The buffering technique is used to smooth out the delays due to packet transmission. The phone switch 600 further performs compression and decompression 613 through any of a number of known techniques.

The phone switch 600 is logically divided into two portions, a routing portion for sending and receiving data over the packet switched computer network 200, and a voice processing card portion for interfacing to the circuit switched telephone network 300. The two portions preferably communicate through a data bus. The routing portion performs the function of routing multiple connections over the packet switched computer network 200.

The voice processing card portion of the phone switch 600 consists of one or more voice processing cards, also known as telephone interface cards, which are typically inserted into input/output slots in the phone switch 600. The voice processing cards handle call control, including sending or detecting the appropriate signals for going off-hook, dialing phone numbers, ring detection, answer detection, busy detection, and disconnect detection and signalling. The voice processing cards also perform analog to digital (A/D) and digital to analog (D/A) conversion where the interface to the circuit switched telephone network is an analog format or protocol. Alternatively, the voice processing cards perform the necessary protocol conversion where the circuit switched telephone network interface is digital, such as a T1 connection. These conversions are typically transparent to the routing portion of the phone switch 600. Additionally, the voice processing cards perform data compression and decompression as described below. Voice processing cards and associated software drivers are available from a number of manufacturers, including Dialogic, Rhetorex, or National Microsystems. Each voice processing card preferably provides a multichannel interface for handling several simultaneous phone conversations.

Referring now to FIG. 4A, call establishment and routing from the phone switch 600 to the circuit switched telephone network is described. The phone switch 600 is an event-driven system. The phone switch 600 typically must respond to the following events and perform the following functions:

Establish new calls upon receiving an authorized call connection request packet. The phone switch 600 must verify the connection request packet, dial the called party's phone number over the circuit switched telephone network 300, wait for the called party to answer, and update the connection database.

Disconnect existing call setups upon receiving a disconnect signal on the set-up channel from the circuit switched telephone network or a disconnect packet through the packet switched computer network.

Decompress digital packet data from the packet switched computer network upon receiving a voice packet, and convert to a format (“protocol”) suitable for the circuit switched telephone network.

Digitize and compress voice data received from the circuit switched telephone network and convert to a packetized protocol for the packet switched computer network.

Perform Audio Buffering.

Perform database updates for billing purposes on establishment and disconnection of the voice conversation.

Network and Communication Protocols

The general mechanisms and protocols for communicating through packet switched computer networks, such as the Internet, and the circuit switched telephone network, are known in the art. See, e.g., Stallings, W., Data and Computer Communications, Second Edition, Macmillan Publishing Co. (1988). Communication over the packet switched network is preferably implemented through a set of standardized application layer protocols. The most preferred embodiment of the packet switched computer network utilizes the TCP (Transport Control Protocol) and Internet Protocol (IP protocols), or alternatively, the OSI layer model, which are also well known in the art. See, e.g., Martin J., TCP/IP Networking, PTR Prentice Hall (1994).

The phone switch 600 is preferably adaptable to a variety of telephone network interfaces, however, most preferably supports connection to a digital T1 line. In typical POTS service, analog telephone wires extend from a user's POTS set to a telephone company central station which converts the analog telephone signals to digital signals by sampling. In-band signalling is typically used to transmit call control information. The analog signals are typically sampled at 8,000 samples per second using 8 bits per sample. The resulting digital signals are commonly combined over a four wire line commonly called a T1 line. Each T1 line multiplexes 24 voice channels by well known multiplexing techniques, in accordance with the standards established by the International Standards Organization (ISO). See, in general, Stallings, Data and Computer Communications, (ch. 6). Modification of the phone switch 600 to support other protocols, including Comit Consultatir International de Tlphonie et de Tlgraphie (CCITT) E1 lines, or other digital or analog transmission protocols, would be obvious to one of ordinary skill in the art. Methods for establishing telephone calls from the phone switch 600 through the telephone network interface are also known to those of skill in the art.

In order to reduce packet overhead, and because errors detected by the TCP protocol may introduce excessive delays not suitable for voice conversation, the system preferably will use a connectionless transport layer protocol for the transmission of voice information over the packet switched computer network. Such connectionless protocols provide no error recovery and do not guarantee sequenced data delivery. The most preferred system will utilize the User Datagram Protocol (UDP), which is well known to those of skill in the art. See, e.g., Martin J., TCP/IP Networking (ch. 8). Certain control information, however, such as call connection requests and database information, preferably will use the TCP protocol (FIG. 4B).

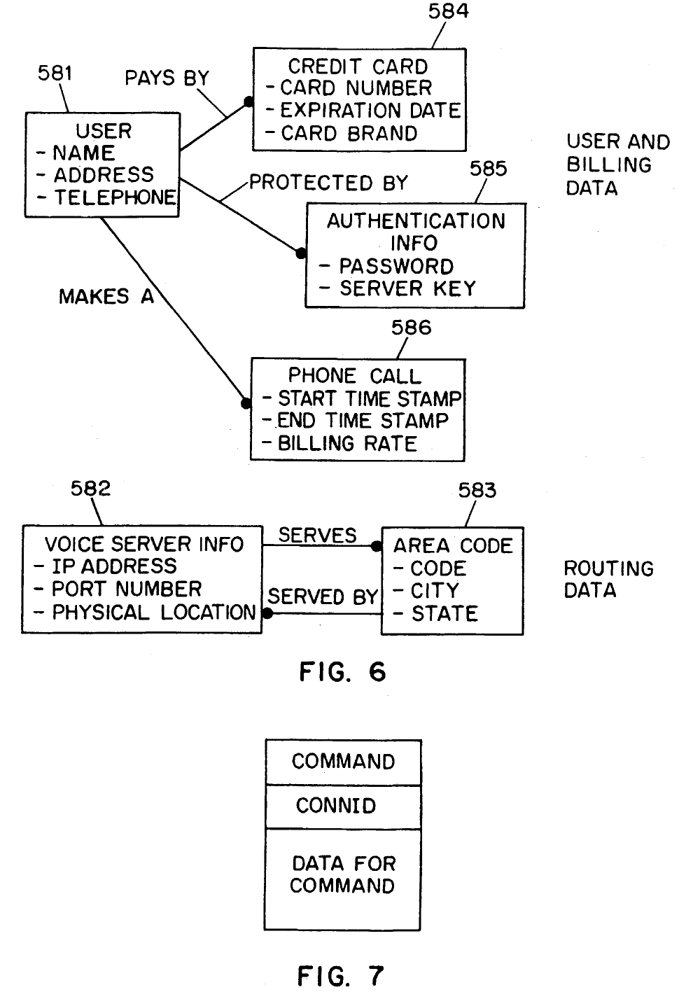

Referring now to FIG. 6, the content of the packets transmitted over the packet switch computer network will be described. Each packet will have a command, followed by a connection id (ConnId), followed by the data for that type of command. The connection id is used to determine the higher level connection, and optionally to demultiplex many connections from a single host. The packet data may be encrypted for security reasons and to protect the user's privacy.

The different types of commands supported by the system include:

Registration Request

Command

ConnId

User name

Password

Credit Card Info

Authorization/Routing Request

Command

ConnId

Destination Telephone Number

User Name

Password

Phone Connect Request

Command

ConnId

Destination Telephone Number

Server Key

Compression Schemes

Voice Data Packet

Command

ConnId

Voice Data

Phone Disconnect Request

Command

ConnId

Registration Response Packet

Command

ConnId

Result Data

Authorization Routing Response Packet

Command

ConnId

Status

Server Key

Phone Connect Response Packet

Command

ConnId

Result Data

Error Packet

Command

ConnId

Reason

Referring now to FIG. 2B, a system for connecting two POTS sets, wherein at least a portion of the call connection path is traversed over a packet switched computer network, will be described. A first user goes off hook on a first POTS set 401 and accesses a first phone switch 650 via a first circuit switched telephone network 300 The user then enters Touch Tone data, including billing information and the called station number. Tone detectors on the first phone switch 650 capture this data. The first phone switch 650 then generates a call connection request which is forwarded by the packet switched computer network 200 to the router authentication server 500. The router authentication server 500 selects a destination phone switch 600 and returns the network address of the destination phone switch 600. The first phone switch 650 then accesses the destination phone switch 500 and calls are processed as described above for computer to POTS calls.

DATABASE ENGReferring now to FIGS. 5 and 6, the database 580 will be described. The database 580 stores the routing, registration, authentication and billing data and may be either distributed or centralized as is known to those of skill in the art. A number of vendors provide tools for constructing such databases, including Sybase and Oracle.

The database 580 includes data relating to user and billing information and server routing information. The database 580 will include a record 582 for each phone switch 600 including the phone switch's Internet IP address and port number, as well as its physical location. The phone switch records 582 will be mapped to a set of area code records 583, such that the system may readily determine all area codes serviced by the phone switch 600. The area code record 583 will also be mapped back to phone switch record 582 to facilitate determining which phone switch to route a given call to.

Each user will be represented by a user record 581 which will contain the user's name, address and telephone number. Each user record 581 will be mapped to several other fields or records, including: the user's credit card record 584; an authentication information record 585, including the user's password; and a set of phone call records 586 for each call the user has made in a certain time frame. Each call record will include the call's start time, end time and billing rate.

It is understood that various other modifications will be apparent to and can be readily made by those skilled in the art without departing from the scope and spirit of the present invention. For example, it will be apparent to those of skill in the art to substitute digital or other telephone sets or other user phone systems, such as a PBX (Private Branch Exchange), in place of the POTS sets described. Accordingly, it is not intended that the scope of the claims be limited to the description or illustrations set forth herein, but rather that the claims be construed as encompassing all features of patentable novelty that reside in the present invention, including all features that would be treated as equivalents by those skilled in the art.

1. A system for routing and transmitting voice conversations, said system comprising:
a circuit switched telephone network supporting at least one voice protocol for routing and transmitting voice conversations;
a plurality of telephone sets coupled to said circuit switched telephone network, each of said plurality of telephone sets having a unique telephone number for access through said circuit switched telephone network;
a packet switched computer network supporting a digital data packet protocol; an audio ready computer coupled to said packet switched computer network, said audio ready computer for converting analog voice signals into said digital data packet protocol and for converting digital data received from said packet switched computer network into analog signals, said audio ready computer generating and forwarding upon user command, via said packet switched computer network, a packetized call connection request comprising a called telephone number;
and at least one phone switch having a network address on said packet switched network and coupled to said circuit switched telephone network, said phone switch for establishing a voice connection to a telephone set identified through its unique telephone number through said circuit switched telephone network and for converting voice information and control information between said digital data packet protocol and said at least one voice protocol, whereby the audio ready computer establishes a voice connection by forwarding a call request containing a unique telephone number to the phone switch which establishes a voice connection to the called telephone set and converts the protocols between the circuit switched telephone network and the packet switched computer network.

2. The system for routing and transmitting voice conversations of claim 1, wherein said audio ready computer further comprises: a database for mapping telephone area codes and exchanges to said at least one phone switch; and a selection means for selecting a one of said at least one phone switches based on said database mapping.

3. The system for routing and transmitting voice conversations of claim 1, wherein said packetized call connection request further comprises user payment information; said system for routing and transmitting voice conversations further comprising an authentication means for verifying the user payment information.

4. The system for routing and transmitting voice conversations of claim 3, wherein said user payment information comprises a user password.

5. The system for routing and transmitting voice conversations of claim 3, wherein said user payment information comprises credit card information.

6. The system for routing and transmitting voice conversations of claim 1, wherein said packet switched computer network is the Internet.

7. A method for establishing and transmitting a voice conversation between an audio ready computer coupled to a packet switched computer network and a telephone set coupled to a circuit switched telephone network, said method utilizing a phone switch coupled to said circuit switched telephone network and said packet switched computer network, said method comprising the steps of:
(a) transmitting a call connection request packet containing a telephone number identifying the telephone set from said audio ready computer to said phone switch;
(b) establishing a voice connection between said phone switch and said telephone set through said circuit switched telephone network;
(c) transmitting, in a digital packet protocol format, voice input received by said audio ready computer during said voice conversation to said phone switch via said packet switched computer network;
(d) transmitting, in a telephone voice and control information protocol format, voice input received by said telephone set during said voice conversation to said phone switch via said circuit switched telephone network;
(e) converting the digital packet formatted voice input received at said phone switch to a telephone voice and control information protocol;
(f) transmitting said converted information from step (e) to said telephone set via said circuit switched telephone network;
(g) converting the telephone voice and control information formatted voice input received at said phone switch to a digital packet protocol;
(h) transmitting said converted information from step (g) to said audio ready computer via said packet switched computer network; and
(i) reconstructing the digital packet in formation received by said audio ready computer into an analog signal, whereby said phone switch is used to bridge the voice conversation between the circuit switched telephone network protocol and the packet switched computer network protocol.

8. The method for establishing and transmitting a voice conversation of claim (5) wherein steps (c) and (g) further comprise the step of compressing the voice input before transmission across said packet switched computer network; and steps (e) and (i) further comprise the step of decompressing the compressed voice input.

9. The method for establishing and transmitting voice conversation of claim 7 further comprising the steps of: selecting said phone switch from a plurality of phone switches coupled to said packet switched network, said selection based on a database matching telephone numbers to said phone switches.

10. The method of establishing and transmitting a voice conversation of claim 7 further comprising the steps of: transmitting user payment information within the call connection request; and verifying the user payment information before establishing the voice connection of step (b).

11. A system for routing and transmitting voice conversations, said system comprising:
a circuit switched telephone network supporting at least one voice protocol for routing and transmitting voice conversations;
a telephone set coupled to said circuit switched telephone network;
a packet switched computer network supporting a digital data packet protocol;
an audio ready computer coupled to said packet switched computer network, said audio ready computer for converting analog voice signals into said digital data packet protocol and for converting digital data received from said packet switched computer network into analog signals, said audio ready computer generating a packetized call connection request upon user command;
at least one phone switch having a network address on said packet switched network and coupled to said circuit switched telephone network, said phone switch for establishing a voice connection through said circuit switched telephone network and for converting voice information and control information between said digital data packet protocol and said at least one voice protocol; and
a routing server coupled to said packet switched computer network, said routing server for selecting a selected phone switch from said at least one phone switch upon receipt of said packetized call connection request from said audio ready computer, said routing server returning the network address of said selected phone switch to said audio ready computer, whereby said audio ready computer establishes a voice conversation by requesting the routing server to return the network address of a selected phone switch, said audio ready computer transmits all further control and voice data to said network address of said selected phone switch.

12. The system for routing and transmitting voice conversations of claim 11, wherein said packetized call connection request further comprises a user password, said system for routing and transmitting voice conversations further comprising an authentication means for verifying the user password with a system database.

13. The system for routing and transmitting voice conversations of claim 11 wherein said digital data packet protocol includes a connectionless transport layer protocol, said transmission of said digitized voice signals over said packet switched computer network utilizing said connectionless transport layer protocol.

14. The system for routing and transmitting voice conversations of claim 13 wherein said connectionless transport layer protocol is the User Datagram Protocol.

15. A method for establishing and transmitting a voice conversation between an audio ready computer coupled to a packet switched computer network and a telephone set coupled to a circuit switched telephone network, said method utilizing a routing server coupled to said packet switched computer network and a plurality of phone switches coupled to said circuit switched telephone network and said packet switched computer network, said method comprising the steps of:
(a) transmitting a call connection request packet containing a telephone number identifying the telephone set from said audio ready computer to said routing server;
(b) selecting a phone switch from said plurality of phone switches upon receipt of said call connection request packet from said audio ready computer;
(c) transmitting an authorized call connection request packet containing the network address of the selected phone switch from said router to said audio ready computer;
(d) transmitting the authorized call connection request packet to the selected phone switch from said audio ready computer;
(e) establishing a voice connection between said selected phone switch and said telephone set through said circuit switched telephone network;
(f) transmitting, in a digital packet protocol format, voice input received by said audio ready computer during said voice conversation to said selected phone switch via said packet switched computer network;
(g) transmitting, in a telephone voice and control information protocol format, voice input received by said telephone set during said voice conversation to said selected phone switch via said circuit switched telephone network;
(h) converting the digital packet formatted voice input received at said selected phone switch to a telephone voice and control information protocol;
(i) transmitting said converted information from step (h) to said telephone set via said circuit switched telephone network;
(j) converting the telephone voice and control information formatted voice input received at said selected phone switch to a digital packet protocol; and
(k) transmitting said converted information from step (j) to said audio ready computer via said packet switched computer network, whereby said selected phone switch is used to bridge the voice conversation between the circuit switched telephone network protocol and the packet switched computer network protocol.

16. A system for routing and transmitting a voice conversation between a first telephone set and a second telephone set over a packet switched computer network supporting a digital data packet protocol including voice and call set-up information, said system comprising:
a first circuit-switched telephone network coupled to said first telephone set, said first circuit-switched telephone network supporting at least one voice protocol including voice and call set-up information;
a second circuit switched telephone network coupled to said second telephone set, said second circuit switched telephone network supporting at least one voice protocol including voice and call set-up information;
a first phone switch coupled to said first circuit switched telephone network and a second phone switch coupled to said circuit switched telephone network, said first and second phone switches each coupled to said packet switched computer network and each having a unique network address on said packet switched network, said first and second phone switches each for converting between voice and call setup information from said first and second circuit switched telephone networks, respectfully, and said digital data packet protocol, said first phone switch further for generating and transmitting a call connection request over said packet switched computer network upon receiving a touch tone request from said first telephone set, said second phone switch further for establishing a call setup over said circuit switched telephone network to said second telephone set upon receipt of said call connection request from first phone switch, whereby a first user accesses said first phone switch to generate a call request over said packet switched computer network to said second phone switch, said second phone switch then establishes a call to said second telephone set, said first and second phone switches then converting and transmitting voice information received between said telephone sets and said packet switched computer network.

17. A system for routing and transmitting a voice conversation between a first telephone set and a second telephone set over a packet switched computer network supporting a digital data packet protocol including voice and call set-up information, said system comprising:
a plurality of circuit switched telephone networks each supporting at least one voice protocol including voice and call set-up information;
plurality of telephone sets coupled to said plurality of circuit switched telephone networks;
a plurality of phone switches each coupled to said packet switched network and at least one of said circuit switched telephone networks, said plurality of phone switches each having a unique network address on said packet switched network, said plurality of phone switches each for converting voice and call set-up information between said at least one voice protocol and said digital data packet protocol, at least one originating phone switch of said plurality of phone switches capable of generating a call connection request including a called telephone number upon receiving a touch tone request from one of said plurality of telephone sets; and
a routing server coupled to said packet switched computer network, said routing server for selecting a selected phone switch from said plurality of phone switches upon receipt of said call connection request from said originating phone switch, said routing server returning a network address of the selected phone switch to said originating phone switch, whereby a user accesses a first phone switch through a first telephone set coupled to a first circuit switched telephone network and enters a destination telephone number using touch-tone keys, said first phone switch then transmits a call connection request containing said destination telephone number to said routing server which selects a second phone switch based on routing considerations, said second phone switch connects to a second destination telephone set via a second circuit switched telephone network, said first and second phone switches then communicate directly through said packet switched computer network coupling said first and said second telephone sets.

18. A method for routing and transmitting a voice conversation between a first telephone set and a second telephone set over a packet switched computer network, said method utilizing a routing server coupled to said packet switched computer network and a plurality of phone switches coupled to said packet switched computer network, said method comprising the steps of:
(a) accessing a first phone switch from said first telephone set;
(b) generating dialing information corresponding to a telephone number for said second telephone set from said first telephone set;
(c) said first phone switch detecting said dialing information;
(d) transmitting a call connection request packet containing the telephone number from said first phone switch to said routing server;
(e) said routing server selecting a phone switch from said plurality of phone switches upon receipt of said call connection request packet from said first phone switch;
(f) transmitting an authorized call connect-on request packet containing the network address of the selected phone switch from said routing server to said first phone switch;
(g) transmitting the authorized call connection request packet to the selected phone switch from said first phone switch;
(h) establishing a voice connection between said selected phone switch and said second telephone set through a circuit switched telephone network coupling said selected phone switch and said second telephone set;
(i) converting the telephone voice and control formatted voice and control information received at said first phone switch and said selected phone switch to a digital packet protocol and forwarding said converted digital packet voice and control information between said first and said selected phone switches over said packet switched computer network; and
(j) transmitting said converted information from step (i) between said first phone switch and said selected phone switch via said packet switched computer network, whereby said first phone switch and said elected phone switch are used to bridge the voice conversation between said first telephone set and said second telephone set across the packet switched computer network.

19. The method for routing and transmitting voice conversations of claim 18 wherein said dialing information comprises touch tones.
